(19) United States
(12) Patent Application Publication
(10) Pub. No.: US 2026/0351595 A1
(43) Pub. Date: Nov. 5, 2026

(54) POSITIVE ELECTRODE FOR ALL-SOLID-STATE SECONDARY BATTERY AND ALL-SOLID-STATE SECONDARY BATTERY

(71) Applicant: MAXELL, LTD., Otokuni-gun (JP)

(72) Inventors: Shota Taniguchi, Otokuni-gun (JP); Yuki Yamamura, Otokuni-gun (JP); Kentaro Tomita, Otokuni-gun (JP); Kazuki Furukawa, Otokuni-gun (JP)

(73) Assignee: MAXELL, LTD., Otokuni-gun (JP)

(21) Appl. No.: 19/645,526

(22) Filed: Apr. 13, 2026

(30) Foreign Application Priority Data
Apr. 14, 2025 (JP) 2025-066249
Jul. 9, 2025 (JP) 2025-116157

(51) Int. Cl. H01M 4/525; H01M 4/02; H01M 4/131; H01M 4/62; H01M 10/058

(52) U.S. Cl. CPC H01M 4/525; H01M 4/131; H01M 4/625; H01M 10/058; H01M 2004/021; H01M 2004/028; H01M 2300/0071

(57) ABSTRACT

A positive electrode for an all-solid-state secondary battery of the present invention has a positive electrode mixture layer containing a positive electrode active material, a conductive aid, and a solid electrolyte, contains, as the positive electrode active material, a lithium cobalt oxide represented by the following general formula (1): LiₐCo_{1-b-c-d}Mg_{b}Al_{c}M¹_{d}O₂ (1). In the general formula (1), M¹ is at least one element selected from the group consisting of Ni, Mn, Na, Fe, Cu, Zr, Ti, Bi, Ca, F, P, Sr, W, Ba, Nb, Si, Zn, Mo, V, Sn, Sb, Ta, Ge, Cr, K, S, and Er, and a<1.2, 0≤b≤0.1, 0.005≤c≤0.1, and d<0.115]; and the positive electrode mixture layer has a porosity of 12 to 24%. An all-solid-state secondary battery of the present invention has the positive electrode for an all-solid-state secondary battery of the present invention.

### TECHNICAL FIELD

The present invention relates to an all-solid-state secondary battery having excellent life characteristics under a high-temperature environment, and to a positive electrode capable of constituting the all-solid-state secondary battery.

### BACKGROUND ART

As batteries, nonaqueous electrolyte batteries such as lithium-ion batteries using an organic electrolyte have been widely used, and in recent years, in view of the expansion of application fields, higher capacity has been required and use under a high-temperature environment has been required, and, accordingly, demands relating to, for example, improvement in safety have been increasing.

For this reason, attention has been increasing on all-solid-state secondary batteries that can ensure excellent heat resistance by using a molded body of a solid electrolyte instead of an organic electrolyte using an organic solvent, which is a flammable liquid.

Various studies are currently being conducted on all-solid-state secondary batteries. For example, Patent Literature 1 proposes a technology for improving load characteristics and high-temperature storage characteristics of an all-solid-state secondary battery by using a positive electrode active material in which a reaction suppression layer for suppressing a reaction between the positive electrode active material and a solid electrolyte is formed on a surface of lithium cobalt oxide having a specific composition. Specifically, Patent Literature 1 evaluates high-temperature storage characteristics by comparing the discharge capacity of a battery after the battery has been stored under an environment of 60 °C with the discharge capacity before storage.

Patent Literature 2 also proposes a technology for improving load characteristics and high-temperature characteristics of an all-solid-state secondary battery. The all-solid-state secondary battery described in Patent Literature 2 includes a positive electrode having a molded body of a positive electrode mixture using a positive electrode active material powder composed of a core material acting as an active material and a lithium-niobium-containing oxide formed on a surface thereof, and ensures the above characteristics by setting the average particle diameter of the positive electrode active material powder and the content thereof in the positive electrode mixture to specific values and by setting the porosity of the molded body of the positive electrode mixture to 10% or less. Specifically, Patent Literature 2 evaluates high-temperature characteristics by repeating charge-discharge cycles under an environment of 100 °C and comparing the discharge capacity of the battery at the 50th cycle with the discharge capacity at the second cycle.

A technology for improving characteristics of an all-solid-state secondary battery by adjusting the porosity of a molded body of a positive electrode mixture is also disclosed, for example, in Patent Literature 3. In Patent Literature 3, as in Patent Literature 2, improvement of energy density and output characteristics of a battery is achieved by setting the porosity of the molded body of the positive electrode mixture to 10% or less.

### PRIOR ART DOCUMENTS

### Patent Literature

[Patent Literature 1] Japanese Patent Application Publication No. 2021-141007
[Patent Literature 2] Japanese Patent Application Publication No. 2021-163582
[Patent Literature 3] International Publication No. WO 2023/042579

### SUMMARY OF THE INVENTION

### Problem to be Solved by the Invention

The technologies described in Patent Literatures 1 to 3 are all capable of favorably improving the characteristics of all-solid-state secondary batteries. However, in all-solid-state secondary batteries, further improvement in characteristics is required in view of the expansion of application fields and the like. For example, with respect to life characteristics under a high-temperature environment, resistance to higher temperatures is required, and there is still room for improvement even in the technologies described in Patent Literatures 1 to 3.

The present invention has been made in view of the foregoing circumstances, and an object thereof is to provide an all-solid-state secondary battery having excellent life characteristics under a high-temperature environment of, for example, 120 °C or higher, and a positive electrode capable of constituting the all-solid-state secondary battery.

### Means for Solving the Problem

A positive electrode for an all-solid-state secondary battery of the present invention has a positive electrode mixture layer containing a positive electrode active material, a conductive aid, and a solid electrolyte, contains, as the positive electrode active material, a lithium cobalt oxide represented by the following general formula (1), and is characterized in that the positive electrode mixture layer has a porosity of 12 to 24%.

LiₐCo_{1-b-c-d}Mg_{b}Al_{c}M¹_{d}O₂ (1)

In the general formula (1), M¹ is at least one element selected from the group consisting of Ni, Mn, Na, Fe, Cu, Zr, Ti, Bi, Ca, F, P, Sr, W, Ba, Nb, Si, Zn, Mo, V, Sn, Sb, Ta, Ge, Cr, K, S, and Er, and a<1.2, 0<b≤0.1, 0.01≤c≤0.1, and dd<0.115.

An all-solid-state secondary battery of the present invention is characterized in that an electrode body having a positive electrode, a negative electrode, and a solid electrolyte interposed between the positive electrode and the negative electrode is housed in an exterior body, and the positive electrode is the positive electrode for an all-solid-state secondary battery of the present invention.

### Effects of the Invention

According to the present invention, it is possible to provide an all-solid-state secondary battery having excellent life characteristics under a high-temperature environment of, for example, 120 °C or higher, and a positive electrode capable of constituting the all-solid-state secondary battery.

### BRIEF DESCRIPTION OF THE DRAWINGS

FIG. 1 is a cross-sectional view schematically showing an example of the all-solid-state secondary battery of the present invention.

FIG. 2 is a perspective view of a recessed container of the all-solid-state secondary battery of FIG. 1.

FIG. 3 is a perspective view of an elastic conductive member of the all-solid-state secondary battery of FIG. 1.

### DESCRIPTION OF EMBODIMENTS

The positive electrode for an all-solid-state secondary battery of the present invention (hereinafter sometimes simply referred to as a “positive electrode”) has a positive electrode mixture layer containing a positive electrode active material, a conductive aid, and a solid electrolyte, contains, as the positive electrode active material, a lithium cobalt oxide represented by the following general formula (1), and is characterized in that the positive electrode mixture layer has a porosity of 12 to 24%.

LiₐCo_{1-b-c-d}Mg_{b}Al_{c}M¹_{d}O₂ (1)

In the general formula (1), M¹ is at least one element selected from the group consisting of Ni, Mn, Na, Fe, Cu, Zr, Ti, Bi, Ca, F, P, Sr, W, Ba, Nb, Si, Zn, Mo, V, Sn, Sb, Ta, Ge, Cr, K, S, and Er, and a<1.2, 0≤b≤0.1, 0.005≤c≤0.1, and dd<0.115.

In a positive electrode having a molded body of a positive electrode mixture, by reducing its porosity to reduce gaps between the positive electrode active material and the solid electrolyte as much as possible so that they can favorably contact each other, ionic conductivity in the positive electrode mixture layer (for example, the molded body of the positive electrode mixture) can be increased, and the internal resistance of the positive electrode can be lowered. Therefore, in an all-solid-state secondary battery using such a positive electrode, the internal resistance is lowered, and favorable discharge characteristics can be ensured.

However, in such an all-solid-state secondary battery, the resistance value greatly increases under a high-temperature environment of, for example, 120 °C or higher, specifically about 150 °C. This is because, under such a high-temperature environment, reactivity at the interface between the positive electrode active material and the solid electrolyte in the positive electrode mixture layer increases, causing deterioration of the solid electrolyte. When the porosity of the positive electrode mixture layer is very low, since the positive electrode active material and the solid electrolyte are in favorable contact with each other, it is considered that the deterioration of the solid electrolyte proceeds earlier.

Accordingly, in the positive electrode of the present invention, a positive electrode active material having excellent heat resistance is used, and the porosity of the positive electrode mixture layer is adjusted so that deterioration of the solid electrolyte as described above can be suppressed while suppressing a decrease in ionic conductivity as much as possible. Therefore, in an all-solid-state secondary battery having the positive electrode of the present invention (the all-solid-state secondary battery of the present invention), life characteristics under a high-temperature environment can be improved. Details of the present invention will be described below.

<Positive Electrode for an all-Solid-State Secondary Battery>

The positive electrode for an all-solid-state secondary battery of the present invention has a positive electrode mixture layer containing a positive electrode active material and a solid electrolyte, and includes, for example, one composed only of a molded body of a positive electrode mixture and one having a molded body of a positive electrode mixture and a current collector. At least a portion of the current collector may enter the inside of the molded body of the positive electrode mixture and may be integrated with the molded body of the positive electrode mixture to form the positive electrode mixture layer.

In the positive electrode of the present invention, from the viewpoint of improving life characteristics under a high-temperature environment in an all-solid-state secondary battery using the positive electrode, the porosity of the positive electrode mixture layer is 12% or more, preferably 15% or more, and more preferably 16% or more. If the porosity of the positive electrode mixture layer in the positive electrode is too large, the resistance value of the positive electrode increases, and the life characteristics of an all-solid-state secondary battery using the positive electrode under a high-temperature environment also tend to decrease. Therefore, in the positive electrode of the present invention, from the viewpoint of improving the life characteristics of an all-solid-state secondary battery using the positive electrode under a high-temperature environment while suppressing an increase in internal resistance as much as possible, the porosity of the positive electrode mixture layer is 24% or less, preferably 23% or less, and more preferably 20% or less.

The porosity of the positive electrode mixture layer as used in the present specification is a value calculated from the true densities and composition ratios of the respective materials constituting the positive electrode mixture and the mass and apparent volume of the positive electrode mixture. As described above, when the molded body of the positive electrode mixture and the current collector are integrated to form the positive electrode mixture layer, the porosity of the positive electrode mixture layer is determined as a value calculated from the positive electrode mixture and voids, excluding the current collector portion in the positive electrode mixture layer. That is, the volume of the entire positive electrode mixture layer in which the current collector and the molded body of the positive electrode mixture are integrated is determined by measuring the dimensions of the positive electrode mixture layer or the like, and the volume of the current collector calculated from the mass of the current collector measured in advance is subtracted from the volume of the entire positive electrode mixture layer, thereby determining the apparent volume of the positive electrode mixture, which is the sum of the actual volume of the positive electrode mixture not including the volume of the current collector and the volume of voids. Furthermore, the porosity of the positive electrode mixture layer can be determined from the actual volume of the positive electrode mixture calculated based on the true densities and composition ratios of the respective materials constituting the positive electrode mixture and the mass of the positive electrode mixture, and the apparent volume of the positive electrode mixture.

For the positive electrode active material of the positive electrode, the lithium cobalt oxide represented by the general formula (1) [hereinafter referred to as “lithium cobalt oxide (A)”] is used. Lithium cobalt oxide (A) is excellent in heat resistance. Therefore, by using a positive electrode containing lithium cobalt oxide (A) as the positive electrode active material, life characteristics of an all-solid-state secondary battery under a high-temperature environment can be improved.

In the general formula (1) representing lithium cobalt oxide (A) used as the positive electrode active material, the amount a of Li is less than 1.2, preferably less than 1, and more preferably 0.98 or less, from the viewpoint of improving load characteristics of the all-solid-state secondary battery. The amount a of Li in the general formula (1) representing lithium cobalt oxide (A) is preferably 0.9 or more from the viewpoint of improving the true density and reversibility of lithium cobalt oxide (A).

In lithium cobalt oxide (A), Mg has the function of improving stability (stability in a high-voltage region and thermal stability) of lithium cobalt oxide (A), and suppressing elution of Co ions. In the general formula (1) representing lithium cobalt oxide (A), the amount b of Mg is more than 0, but from the viewpoint of more effectively exhibiting the above function, is preferably 0.005 or more, and more preferably 0.01 or more.

Depending on the content ratio of Al or Ti, lithium cobalt oxide (A) can achieve the object of the present invention even when b=0, that is, even when Mg is not contained, in the general formula (1).

In lithium cobalt oxide (A), Al has the function of substituting for a Co site to increase bonding force between a CoO₂ layer and a Li layer and to make its crystal structure stronger. In the general formula (1) representing lithium cobalt oxide (A), the amount c of Al is 0.005 or more, preferably 0.01 or more, and more preferably 0.03 or more, from the viewpoint of effectively exhibiting the above function.

In lithium cobalt oxide (A), Mg and Al contribute, by the above respective functions, to suppressing an increase in internal resistance when an all-solid-state secondary battery using a positive electrode containing lithium cobalt oxide (A) as the positive electrode active material is stored for a long period under a high-temperature environment.

However, when lithium cobalt oxide (A) having an excessively large amount of Ma or Al is used as the positive electrode active material, the internal resistance of the all-solid-state secondary battery increases in a short time after being placed under a high-temperature environment.

Therefore, from the viewpoint of suppressing an increase in internal resistance of the all-solid-state secondary battery in a short time after being placed under a high-temperature environment, in the general formula (1) representing lithium cobalt oxide (A), the amount c of Mg is 0.1 or less, preferably 0.05 or less, and the amount c of Al is 0.1 or less, preferably 0.07 or less.

Lithium cobalt oxide (A) may contain element M¹ or may not contain element M¹. However, when the amount of element M¹ in lithium cobalt oxide (A) is too large, the amounts of other components become too small, and there is a possibility that the functions thereof cannot be sufficiently ensured. Therefore, in the general formula (1) representing lithium cobalt oxide (A), d representing the amount of element M¹ is preferably less than 0.1 (may be 0).

However, by limiting the amounts of Mg and Al in lithium cobalt oxide (A) as described above, the effect of suppressing an increase in internal resistance when the all-solid-state secondary battery is stored for a long period under a high-temperature environment may become small. Therefore, lithium cobalt oxide (A) preferably satisfies the following general formula (2).

LiₐCo_{1-b-c-d-e}Mg_{b}Al_{c}TiₑM²_{f}O₂ (2)

In the general formula (2), M² is at least one element selected from the group consisting of Ni, Mn, Na, Fe, Cu, Zr, Bi, Ca, F, P, Sr, W, Ba, Nb, Si, Zn, Mo, V, Sn, Sb, Ta, Ge, Cr, K, S, and Er, and a<1.2, 0≤b≤0.1, 0.005≤c≤0.1, 0<e≤0.015, and f<0.1.

That is, in the general formula (2), element M² is the same as element M¹ in the general formula (1) except that Ti is not included. In the general formula (2), the amount a of Li, the amount b of Mg, and the amount c of Al are all the same as a, b, and c in the general formula (1). The amount e of Ti and the amount f of element M² in the general formula (2), and the amount d of element M¹ in the general formula (1), have a relationship of d=e+f.

In this way, by causing lithium cobalt oxide (A) to contain Ti as an essential component, the functions of Mg and Al, the contents of which are limited as defined by the general formula (2), are supplemented, and an increase in internal resistance when the all-solid-state secondary battery is stored for a long period under a high-temperature environment can be favorably suppressed.

In the general formula (2) representing lithium cobalt oxide (A), the amount e of Ti is greater than 0, but from the viewpoint of more effectively exhibiting the above function, is preferably 0.001 or more, and more preferably 0.002 or more. However, when the amount of Ti in lithium cobalt oxide (A) is too large, the amounts of other components become too small, and there is a possibility that the functions thereof cannot be sufficiently ensured. Further, it becomes a factor that increases the electrical resistance of the lithium cobalt oxide, and problems such as a decrease in homogeneity of the active material are likely to occur. Therefore, in the general formula (2) representing lithium cobalt oxide (A), the amount e of Ti is preferably 0.015 or less, and more preferably 0.007 or less.

In the general formula (2), the amount f of element M² is preferably less than 0.1 (may be 0) for the same reason as the amount d of element M¹ in the general formula (1).

As the positive electrode active material, only lithium cobalt oxide (A) may be used, or lithium cobalt oxide (A) and another positive electrode active material may be used in combination. Examples of another positive electrode active material that can be used in combination with lithium cobalt oxide (A) include active materials capable of occluding and releasing lithium ions, similar to those used as positive electrode active materials in known lithium-ion secondary batteries. However, when lithium cobalt oxide (A) and another positive electrode active material are used in combination as the positive electrode active material, the proportion of lithium cobalt oxide (A) in all positive electrode active materials is preferably 60 mass % or more. Since all of the positive electrode active material may be lithium cobalt oxide (A), the upper limit value of the preferable content of lithium cobalt oxide (A) in all positive electrode active materials is 100 mass %.

The average particle diameter of the positive electrode active material is preferably 0.1 μm or more, more preferably 0.5 μm or more, and preferably 25 μm or less, more preferably 10 μm or less, from the viewpoint of reducing side reactions that cause capacity deterioration of the battery and increasing the density of the positive electrode mixture layer. The positive electrode active material may be primary particles or secondary particles obtained by aggregation of primary particles. When a positive electrode active material having an average particle diameter in the above range is used, the interface with the solid electrolyte in the positive electrode mixture layer can be increased within a range that does not impair life characteristics under a high-temperature environment, and therefore the load characteristics of the all-solid-state secondary battery are further improved.

The average particle diameter of the positive electrode active material and the average particle diameter of other particles (negative electrode active material, solid electrolyte, and the like), as used in the present specification, mean the value of the 50% diameter (D₅₀) in the cumulative fraction on a volume basis when the integrated volume is determined from particles having a small particle size, using a particle size distribution measuring apparatus (such as a Microtrac particle size distribution measuring apparatus “HRA9320” manufactured by Nikkiso Co., Ltd.).

The positive electrode active material preferably has, on its surface, a reaction suppression layer for suppressing a reaction with the solid electrolyte contained in the positive electrode mixture layer. By providing a reaction suppression layer that suppresses a reaction with the solid electrolyte on the surface of the positive electrode active material and preventing direct contact between the positive electrode active material and the solid electrolyte, a decrease in ionic conductivity in the positive electrode mixture layer due to deterioration of the solid electrolyte (a decrease in life characteristics under a high-temperature environment caused thereby) can be more favorably suppressed.

The reaction suppression layer may be composed of any material that has ionic conductivity and can suppress a reaction between the positive electrode active material and the solid electrolyte. Examples of the material capable of constituting the reaction suppression layer include an oxide containing Li and at least one element selected from the group consisting of Nb, P, B, Si, Ge, Ti, Zr, Ta, and W, and more specifically, an Nb-containing oxide such as LiNbO₃, Li₃PO₄, Li₃BO₃, Li₄SiO₄, Li₄GeO₄, LiTiO₃, LiZrO₃, and Li₂WO₄. The reaction suppression layer may contain only one of these oxides, may contain two or more thereof, or a plurality of these oxides may form a composite compound. Among these oxides, it is preferable to use an Nb-containing oxide, and it is more preferable to use LiNbO₃.

The reaction suppression layer is preferably present on the surface in an amount of 0.1 to 2.0 parts by mass relative to 100 parts by mass of the positive electrode active material. Within this range, a reaction between the positive electrode active material and the solid electrolyte can be favorably suppressed.

Examples of a method for forming the reaction suppression layer on the surface of the positive electrode active material include a sol-gel method, a mechanofusion method, a CVD method, a PVD method, and an ALD method.

The content ratio of the positive electrode active material in the positive electrode mixture is preferably 20 to 95 mass %.

The positive electrode mixture contains a solid electrolyte. The solid electrolyte is not particularly limited as long as it has Li ion conductivity, and, for example, a sulfide-based solid electrolyte, a hydride-based solid electrolyte, a halide-based solid electrolyte, an oxide-based solid electrolyte, and the like can be used.

Examples of the sulfide-based solid electrolyte include particles such as Li₂S—P₂S₅, Li₂S—SiS₂, Li₂S—P₂S₅—GeS₂, and Li₂S—B₂S₃-based glass. In addition, thio-LISICON-type materials attracting attention in recent years as having high Li ion conductivity [L₁₀GeP₂S₁₂, Li_{9.54}Si_{1.74}P_{1.44}S_{11.7}Cl_{0.3}, and the like, represented by Li_{12-12a-b+c+6d-e}M¹_{3+a-b-c-d}M²_{b}M³_{c}M⁴_{d}M⁵₁₂₋ₑXₑ (provided that M¹ is Si, Ge, or Sn, M² is P or V, M³ is Al, Ga, Y, or Sb, M⁴ is Zn, Ca, or Ba, M⁵ is either S or S and O, X is F, Cl, Br, or I, 0≤a<3, 0≤b+c+d≤3, and 0≤e≤3)], and argyrodite-type materials [such as those represented by Li₇₋ₖPS₆₋ₖXₖ, such as Li₆PS₅Cl (provided that X represents one or more halogen elements and 0.2<k<2.0), those represented by Li_{7-f+g}PS_{6-f}Cl_{f+g} (provided that 0.05≤g≤0.9 and −3.0f+1.8≤g≤−3.0f+5.7), and those represented by Li₇₋ₕPS₆₋ₕClᵢBrⱼ (provided that h=i+j, 0<h≤1.8, and 0.1≤i/j≤10.0)] can also be used.

Examples of the hydride-based solid electrolyte include LiBH₄ and a solid solution of LiBH₄ and the following alkali metal compound (for example, one in which the molar ratio of LiBH₄ to the alkali metal compound is 1:1 to 20:1). Examples of the alkali metal compound in the solid solution include at least one selected from the group consisting of lithium halides (LiI, LiBr, LiF, LiCl, and the like), rubidium halides (RbI, RbBr, RbF, RbCl, and the like), cesium halides (CsI, CsBr, CsF, CsCl, and the like), lithium amide, rubidium amide, and cesium amide.

Examples of the halide-based solid electrolyte include monoclinic LiAlCl₄, defective spinel-type or layered-structure LiInBr₄, and monoclinic Li₆₋₃ₘYₘX₆ (provided that 0<m<2 and X═Cl or Br). In addition, known materials described, for example, in International Publication No. WO 2020/070958 and International Publication No. WO 2020/070955 can also be used.

Examples of the oxide-based solid electrolyte include Li₂O—Al₂O₃—SiO₂—P₂O₅—TiO₂-based glass ceramics, Li₂O—Al₂O₃—SiO₂—P₂O₅—GeO₂-based glass ceramics, garnet-type Li₇La₃Zr₂I₁₂, NASICON-type Li_{1+O}Al_{1+O}Ti_{2-O}(PO₄)₃ and Li₁₊ₚAl₁₊ₚGe₂₋ₚ(PO₄)₃, and perovskite-type Li_{3q}La_{2/3-q}TiO₃.

Among these solid electrolytes, a sulfide-based solid electrolyte is preferable because of high Li ion conductivity, a sulfide-based solid electrolyte containing Li and P is more preferable, and an argyrodite-type sulfide-based solid electrolyte having particularly high Li ion conductivity and high chemical stability is still more preferable.

The content ratio of the solid electrolyte in the positive electrode mixture is preferably 4 to 80 mass %.

The positive electrode mixture can contain a conductive aid. Examples of the conductive aid for the positive electrode include carbon materials such as carbon black (thermal black, furnace black, channel black, Ketjen black, acetylene black, and the like), graphite (natural graphite and artificial graphite), graphene, vapor-grown carbon fibers, carbon nanofibers, and carbon nanotubes; powders of simple substances of Cu, Ni, Al, Au, and Pd or alloys thereof, or porous bodies thereof, and the like. These may be used singly or in combination of two or more.

In molding a positive electrode mixture containing graphene as a conductive aid, when the surface pressure during pressing is increased, the graphene is oriented, but after the molded positive electrode mixture is taken out of the molding die, the graphene undergoes springback, which causes microcracks in the molded body. In an all-solid-state secondary battery using a positive electrode having a molded body of a positive electrode mixture in which such cracks are formed, life characteristics under a high-temperature environment are more likely to decrease. However, with the positive electrode of the present invention, even when graphene is used as the conductive aid, it is possible to favorably suppress a decrease in life characteristics under such a high-temperature environment in the all-solid-state secondary battery. Therefore, in the present invention, when graphene is used as the conductive aid for the positive electrode, the effect is exhibited more significantly.

The content ratio of the conductive aid in the positive electrode mixture is preferably 0.1 to 15 mass %.

The positive electrode mixture may contain a binder, and when favorable moldability can be ensured without using a binder, such as in a positive electrode in which a sulfide-based solid electrolyte is contained and powder of the positive electrode mixture is introduced into a molding die and compacted, the binder does not need to be contained.

Examples of the binder contained in the positive electrode mixture include fluororesins such as polyvinylidene fluoride (PVDF) and polytetrafluoroethylene (PTFE).

When the positive electrode mixture contains a binder, the content ratio thereof in the positive electrode mixture is preferably 15 mass % or less, more preferably 5 mass % or less, and preferably 0.5 mass % or more. On the other hand, when a binder is not required from the viewpoint of moldability of the positive electrode mixture, the content ratio thereof in the positive electrode mixture is preferably 0.5 mass % or less, more preferably 0.3 mass % or less, and still more preferably 0 mass % (that is, no binder is contained).

When a current collector is used for the positive electrode, a foil of a metal, punching metal, mesh, expanded metal, foamed metal, made of e.g., aluminum or stainless steel; a carbon sheet; or the like can be used as the current collector.

The molded body of the positive electrode mixture can be formed, for example, by mixing a positive electrode active material, a conductive aid, and a solid electrolyte, and, if necessary, a binder and the like, to prepare a positive electrode mixture, and compressing the positive electrode mixture by pressure molding or the like.

In the case of a positive electrode having a current collector, the positive electrode can be manufactured by bonding the molded body of the positive electrode mixture formed by the above method to the current collector by pressure bonding or the like.

The thickness of the positive electrode mixture layer (in the case of a positive electrode having a current collector, the thickness of the positive electrode mixture layer per one surface of the current collector; the same applies hereinafter) is preferably 200 μm or more from the viewpoint of increasing the capacity of the battery. The thickness of the positive electrode mixture layer is usually 2000 μm or less.

### <All-Solid-State Secondary Battery>

The all-solid-state secondary battery of the present invention has a positive electrode, a negative electrode, and a solid electrolyte layer interposed between the positive electrode and the negative electrode, and the positive electrode is the positive electrode for an all-solid-state secondary battery of the present invention.

### (Negative Electrode)

The negative electrode of the all-solid-state secondary battery can be, for example, one having a negative electrode mixture layer containing a negative electrode active material, a conductive aid, a solid electrolyte, and the like. Specific examples include one composed only of a molded body of a negative electrode mixture and one having a structure in which a molded body of a negative electrode mixture and a current collector are integrated. At least a portion of the current collector may enter the inside of the molded body of the negative electrode mixture and may be integrated with the molded body of the negative electrode mixture to form the negative electrode mixture layer.

As the negative electrode active material, for example, one or a mixture of two or more carbon-based materials capable of occluding and releasing lithium, such as graphite, pyrolytic carbons, cokes, glassy carbons, fired bodies of organic polymer compounds, mesocarbon microbeads (MCMB), and carbon fibers, can be used. In addition, simple substances, compounds, and alloys thereof containing elements such as Si, Sn, Ge, Bi, Sb, and In; lithium-containing nitrides or compounds such as lithium-containing oxides capable of charge and discharge at a low voltage close to that of lithium metal; lithium metal; and lithium/aluminum alloys can also be used as the negative electrode active material.

The content of the negative electrode active material in the negative electrode mixture is preferably 50 to 95 mass %.

As the conductive aid for the negative electrode, carbon materials such as graphite (natural graphite and artificial graphite), graphene, carbon black, carbon nanofibers, and carbon nanotubes can be used. The content of the conductive aid in the negative electrode mixture is preferably 1 to 10 mass %.

As the solid electrolyte of the negative electrode, one or two or more of the same solid electrolytes as those exemplified above as solid electrolytes that can be contained in the positive electrode mixture can be used. Among the exemplified solid electrolytes, it is more preferable to use a sulfide-based solid electrolyte because it has high lithium ion conductivity and has a function of improving moldability of the negative electrode mixture.

The content of the solid electrolyte in the negative electrode mixture is preferably 4 to 49 mass %.

The negative electrode mixture does not need to contain a resin binder, but may contain a resin binder. Examples of the resin binder include fluororesins such as polyvinylidene fluoride (PVDF) and polytetrafluoroethylene (PTFE). However, since the resin binder also acts as a resistance component in the negative electrode mixture, it is desirable that the amount thereof be as small as possible. Therefore, in the negative electrode mixture, it is preferable not to contain the resin binder, or, when the resin binder is contained, to set the content thereof to 0.5 mass % or less. The content of the resin binder in the negative electrode mixture is more preferably 0.3 mass % or less, and still more preferably 0 mass % (that is, no resin binder is contained).

When a current collector is used for the negative electrode, a foil, punching metal, mesh, expanded metal, foamed metal, made of e.g., copper or nickel; a carbon sheet, or the like can be used as the current collector.

The molded body of the negative electrode mixture can be formed, for example, by mixing a negative electrode active material, a conductive aid, and a solid electrolyte, and, if necessary, a binder and the like, to prepare a negative electrode mixture, and compressing the negative electrode mixture by pressure molding or the like.

In the case of a negative electrode having a current collector, the negative electrode can be manufactured by bonding the molded body of the negative electrode mixture formed by the above method to the current collector by pressure bonding or the like.

The thickness of the negative electrode mixture layer (in the case of a negative electrode having a current collector, the thickness of the negative electrode mixture layer per one surface of the current collector; the same applies hereinafter) is preferably 200 μm or more from the viewpoint of increasing the capacity of the battery. The thickness of the negative electrode mixture layer is usually 3000 μm or less.

### (Solid Electrolyte Layer)

As the solid electrolyte in the solid electrolyte layer, one or two or more of the same solid electrolytes as those exemplified above as the solid electrolyte of the positive electrode can be used. However, in order to further improve battery characteristics, it is desirable to contain a sulfide-based solid electrolyte, and it is more desirable that all of the positive electrode, the negative electrode, and the solid electrolyte layer contain a sulfide-based solid electrolyte.

The solid electrolyte layer may have a porous body such as a resin nonwoven fabric as a support.

The solid electrolyte layer can be formed by a method of compressing the solid electrolyte by pressure molding or the like; a method of applying a composition for forming a solid electrolyte layer, prepared by dispersing the solid electrolyte in a solvent, onto a base material, a positive electrode, or a negative electrode, drying the composition, and, if necessary, performing pressure molding such as press treatment; and the like.

As the solvent used in the composition for forming a solid electrolyte layer, it is preferable to select a solvent that is unlikely to deteriorate the solid electrolyte. In particular, since sulfide-based solid electrolytes and hydride-based solid electrolytes undergo a chemical reaction with a very small amount of moisture, it is preferable to use a nonpolar aprotic solvent represented by hydrocarbon solvents such as hexane, heptane, octane, nonane, decane, decalin, toluene, and xylene. In particular, it is more preferable to use a super-dehydrated solvent having a water content of 0.001 mass % (10 ppm) or less. Fluorine-based solvents such as “Vertrel (registered trademark)” manufactured by Chemours-Mitsui Fluoroproducts Co., Ltd., “ZEORORA (registered trademark)” manufactured by Zeon Corporation, and “Novec (registered trademark)” manufactured by Sumitomo 3M Limited, and nonaqueous organic solvents such as dichloromethane and diethyl ether can also be used.

The thickness of the solid electrolyte layer is preferably 100 to 300 μm.

### (Electrode Body)

The positive electrode and the negative electrode can be used in a battery in the form of a stacked electrode body in which the positive electrode and the negative electrode are stacked via the solid electrolyte layer, or a wound electrode body obtained by further winding the stacked electrode body.

When forming the electrode body, it is preferable to perform pressure molding in a state in which the positive electrode, the negative electrode, and the solid electrolyte layer are stacked, from the viewpoint of improving mechanical strength of the electrode body.

### (Form of Battery)

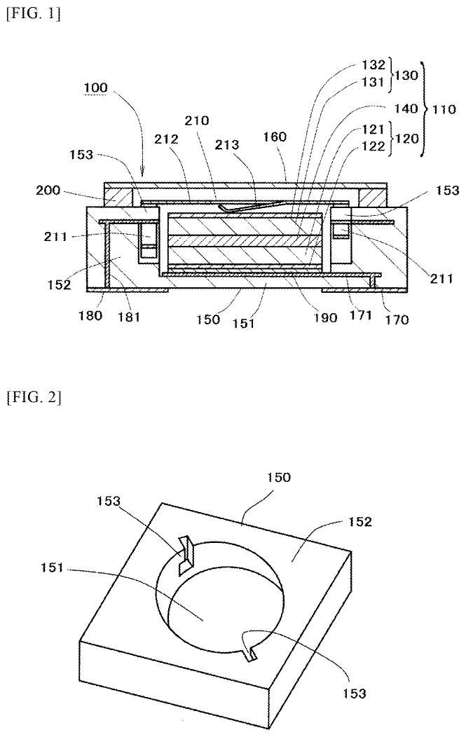

FIG. 1 shows a longitudinal cross-sectional view schematically showing an example of the all-solid-state secondary battery of the present invention. An all-solid-state secondary battery 100 shown in FIG. 1 has a stacked electrode body 110 having a positive electrode 120, a negative electrode 130, and a solid electrolyte layer 140 interposed therebetween, and the stacked electrode body 110 is sealed in a battery container (exterior body) formed by a recessed container 150 and a sealing body 160.

FIG. 2 shows a perspective view schematically showing the recessed container 150 constituting the battery container of the all-solid-state secondary battery 100 shown in FIG. 1. As shown in FIG. 2, the recessed container 150 is composed of a bottom portion 151 and a side wall portion 152, and has a recessed cross-sectional shape having an opening that opens upward in the drawing.

The battery 100 shown in FIG. 1 is an example having a positive electrode 120 composed of a positive electrode mixture layer having a molded body 121 of a positive electrode mixture and a positive electrode current collector 122, and a negative electrode 130 composed of a negative electrode mixture layer having a molded body 131 of a negative electrode mixture and a negative electrode current collector 132. The positive electrode 120 and the negative electrode 130 are stacked via the solid electrolyte layer 140 to constitute the stacked electrode body 110. In FIG. 1, the positive electrode 120 is illustrated such that the molded body 121 of the positive electrode mixture and the positive electrode current collector 122 are separate layers and are in close contact with each other at opposing surfaces thereof; however, the molded body 121 of the positive electrode mixture can enter the inside of the porous positive electrode current collector 122, and the two can be integrated to constitute the positive electrode mixture layer. In FIG. 1, in the negative electrode 130 as well, the molded body 131 of the negative electrode mixture and the negative electrode current collector 132 are illustrated such that they are separate layers and are in close contact with each other at opposing surfaces thereof; however, the molded body 131 of the negative electrode mixture can enter the inside of the porous negative electrode current collector 132, and the two can be integrated to constitute the negative electrode mixture layer.

On the lower side in the drawing of the recessed container 150, connection terminal portions 170 and 180 for electrically connecting the all-solid-state secondary battery 100 to equipment in which it is used are provided. The connection terminal portion 170 is conductively connected to a conductive path 171 extending from the inside of the recessed container 150 to the external connection terminal portion 170. The conductive path 171 is conductively connected to the positive electrode 120 of the stacked electrode body 110 housed in the recessed container 150, whereby the positive electrode 120 of the stacked electrode body 110 and the connection terminal portion 170 are electrically connected. In the all-solid-state secondary battery 100 of FIG. 1, a porous metal base material 190, which is a conductive connection member, is interposed between the positive electrode 120 of the stacked electrode body 110 and the conductive path 171. In the all-solid-state secondary battery 100, as described above, by the action of the porous metal base material 190, conductivity between the positive electrode 120 and the conductive path 171 can be improved, and occurrence of variation in internal resistance of individual batteries when many all-solid-state secondary batteries are manufactured can be suppressed.

The connection terminal portion 180 is conductively connected to a conductive path 181 extending from the inside of the recessed container 150 to the external connection terminal portion 180, and this conductive path 181 is disposed at an upper portion in the drawing of the stacked electrode body 110 and is conductively connected to the negative electrode 130 via an elastic conductive member 210 that contacts the negative electrode 130 of the stacked electrode body 110. As a result, the negative electrode 130 of the stacked electrode body 110 and the connection terminal portion 180 are electrically connected.

The side wall portion 152 of the recessed container 150 has a support portion 153 that supports the elastic conductive member 210. In the all-solid-state secondary battery 100, as shown in FIG. 2, the support portion 153 is an overhanging portion formed at an upper end portion of the inner peripheral surface of the side wall portion 152 and protruding in the radial direction; however, the support portion for holding the elastic conductive member of the all-solid-state secondary battery may have another shape as long as it can support the elastic conductive member 210.

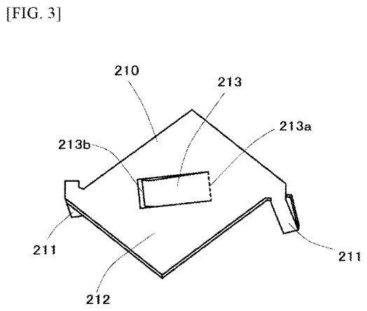

FIG. 3 shows a perspective view schematically showing the elastic conductive member 210 included in the all-solid-state secondary battery 100 shown in FIG. 1. The elastic conductive member 210 is formed of, for example, a thin metal plate, and, as shown in FIG. 3, has a quadrangular shape in plan view, but can have a shape corresponding to the plan-view shape of the stacked electrode body or the recessed container included in the all-solid-state secondary battery.

The recessed container 150 of the all-solid-state secondary battery 100 shown in FIG. 1 has, at the upper end portion of its side wall portion 152, a plurality of support portions 153 for supporting the elastic conductive member 210. A portion of the conductive path 181 is exposed at a portion of the support portion 153 that contacts the elastic conductive member 210. The support portions 153 are formed at least in a number corresponding to the number of supported portions 211 of the elastic conductive member 210 described later.

The elastic conductive member 210 has supported portions 211 and a planar portion 212. The supported portions 211 are provided in plurality at locations corresponding to the positions of the support portions 153, at positions radially outward in plan view of the stacked electrode body 110 of the all-solid-state secondary battery 101. Each supported portion 211 has a tip folded back toward the support portion 153, that is, toward the lower surface of the top wall. The tip of the supported portion 211 contacts the conductive path 181 exposed at the support portion 153. Thus, the elastic conductive member 210 functions as a current collector and forms a part of a conductive path that electrically connects the negative electrode 130 and the connection terminal portion 180.

The elastic conductive member 210 is supported by the support portions 153 formed on the inner peripheral surface of the side wall portion 152 of the recessed container 150, and covers a part of the opening of the recessed container 150. The area of the elastic conductive member 210 in plan view is smaller than the opening area of the recessed container 150.

As shown in FIGS. 1 and 3, the elastic conductive member 210 has a spring portion 213 rising from the planar portion 212 toward the negative electrode 130 of the stacked electrode body 110, and this spring portion 213 contacts the upper surface in the drawing of the negative electrode 130 (negative electrode current collector 132) of the stacked electrode body 110 and presses the stacked electrode body 110 toward the inner bottom surface of the recessed container 150.

In the elastic conductive member having the spring portion, the shape of the spring portion is not particularly limited as long as it can press the stacked electrode body toward the inner bottom surface of the recessed container. The spring portion 213 included in the elastic conductive member 210 shown in FIGS. 1 and 3 is a spring piece inclined from the planar portion 212 toward the negative electrode 130 of the stacked electrode body 110 (hereinafter the spring portion 213 may be referred to as a spring piece 213). As shown in FIG. 3, the spring piece 213 is formed by making a U-shaped cut in a portion of the planar portion 212, and is cantilever-supported by the planar portion 212. That is, the spring piece 213 in the elastic conductive member 210 shown in FIGS. 1 and 3 is a leaf spring. With the elastic conductive member 210 in such a form, since the spring piece 213 only needs to be formed in a portion of the planar portion 212, manufacture of the elastic conductive member, and consequently manufacture of the all-solid-state secondary battery, can be performed more easily. In addition, by making a cut in the planar portion 212 to form the spring piece 213, manufacture of the elastic conductive member, and consequently manufacture of the all-solid-state secondary battery, can be performed even more easily.

The spring piece 213 has a boundary 213a with the planar portion 212 and a tip portion 213b, and is bent at the boundary 213a to contact the negative electrode 130 of the stacked electrode body 110 and is inclined from the boundary 213a toward the tip portion 213b toward the stacked electrode body 110 side. However, if the tip portion 213b of the spring piece 213 is brought into contact with the negative electrode 130 of the stacked electrode body 110, the negative electrode 130 may be damaged by the tip portion 213b. Therefore, in the elastic conductive member 210 shown in FIGS. 1 and 3, the spring piece 213 is bent so that the tip portion 213b faces upward in FIG. 2, and the spring piece 213 contacts the negative electrode 130 at a portion other than the tip portion 213b.

In the elastic conductive member 210 before the all-solid-state secondary battery 100 is assembled, the height from the bottom surface of the planar portion 212 to the portion where the spring piece 213 contacts the negative electrode 130 (the height of the spring piece 213) is greater than the height from the bottom surface of the planar portion 212 to the portion where the elastic conductive member 210 contacts the negative electrode 130 after the all-solid-state secondary battery 100 is assembled. Accordingly, the stacked electrode body 110 can be pressed by the spring piece 213, and favorable electrical connection between the elastic conductive member 210 and the negative electrode 130 of the stacked electrode body 110 can be maintained.

In the elastic conductive member 210, by forming the spring portion 213 as a spring piece, the thickness of the elastic conductive member 210 excluding the supported portions 211 can be reduced.

The elastic conductive member having spring pieces may have a plurality of spring pieces. In that case, the shapes including the widths and lengths of the spring pieces may be individually different for reasons such as preventing resonance.

In the elastic conductive member 210, the spring piece 213 may be formed by making a cut in the planar portion 212 as described above, or may be attached by separately welding the spring piece 213 to the bottom surface of the planar portion 212 having a planar shape. In addition, a base portion for attaching the spring piece 213 may be provided in advance separately from the planar portion 212, and the spring piece 213 may be attached to the base portion to form the entire spring portion. That is, the spring piece 213 may rise directly from the planar portion 212, or may rise from the planar portion 213 with another element such as a base portion interposed therebetween. Furthermore, the spring piece 213 may have a form in which both ends of the spring piece 213 are supported by the planar portion 212 so that the spring piece 213 has a convex shape toward the stacked electrode body 110.

In the all-solid-state secondary battery 100 shown in FIG. 1, when installing the elastic conductive member 210, first, after the stacked electrode body 110 is housed inside the recessed container 150, the elastic conductive member 210 is placed on the upper surface of the stacked electrode body 110. In a state in which the elastic conductive member 210 is placed on the upper surface of the stacked electrode body 110, the tips of the supported portions 211 are positioned between the upper surface of the stacked electrode body 110 and the support portions 153 in the axial direction of the stacked electrode body 110 (the vertical direction in FIG. 1). Then, while pushing the supported portions 211 of the elastic conductive member 210 toward the bottom portion 151 of the recessed container 150, the supported portions 211 are supported by the support portions 153. Since the supported portions 211 of the elastic conductive member 210 are pushed downward, the spring pieces 213 are pushed in a direction opposite to the negative electrode 130 while in contact with the stacked electrode body 110. At this time, the spring pieces 213 press the stacked electrode body 110 toward the bottom portion 151 of the recessed container 150 by their elastic force. As a result, the elastic conductive member 210 more stably contacts the stacked electrode body 110 and can maintain favorable electrical connection without positional displacement due to vibration or the like.

Examples of a method for fixing the edge end (supported portion 211) of the elastic conductive member 210 to the inner peripheral surface of the side wall portion 152 of the recessed container 150 include a method of bonding the edge end of the elastic conductive member 210 to the inner peripheral surface of the side wall portion 152 of the recessed container 150.

As shown in FIG. 1, it is preferable that a gap be formed between the elastic conductive member 210 and the sealing body 160. That is, it is preferable that the elastic conductive member 210 and the sealing body 160 are not in contact with each other. Accordingly, even if the elastic conductive member 210 is pushed toward the sealing body 160 side due to a volume change of the stacked electrode body 110, contact between the elastic conductive member 210 and the sealing body 160 can be avoided.

In the all-solid-state secondary battery 100 shown in FIG. 1, the stacked electrode body 110 is disposed so that the positive electrode 120 is located on the inner bottom surface side of the recessed container 150 and the negative electrode 130 is located on the sealing body 160 side (elastic conductive member 210 side). However, an all-solid-state secondary battery can also be configured by disposing the stacked electrode body so that the negative electrode is located on the inner bottom surface side of the recessed container and the positive electrode is located on the sealing body side (elastic conductive member side).

### (Exterior Body)

As the exterior body of the all-solid-state secondary battery, it is possible to use a battery container having a recessed container (exterior container) and a sealing body (lid body) as shown in FIG. 1; a flat (coin-shaped, button-shaped, or the like) or cylindrical (cylindrical, prismatic, or the like) battery container having a metal exterior can and a metal sealing body; a battery container made of a laminate film exterior body composed of a metal laminate film such as an aluminum laminate film; and the like.

In the case of a battery container having a recessed container and a sealing body as shown in FIG. 1, the recessed container can be composed of ceramics or resin. The sealing body can be composed of ceramics, resin, or metal (such as an iron-based alloy such as an iron-nickel alloy or an iron-nickel-cobalt alloy).

In the recessed container, the connection terminal portions and the conductive paths connecting the electrodes of the stacked electrode body and the connection terminal portions can be composed of metals such as manganese, cobalt, nickel, copper, molybdenum, silver, palladium, tungsten, platinum, and gold, or alloys containing these.

The recessed container and the sealing body can be sealed by bonding them together with an adhesive. In addition, when a metal sealing body is used, as shown in FIG. 1, a seal ring 200 made of a metal (such as an iron-based alloy such as an iron-nickel alloy or an iron-nickel-cobalt alloy) is disposed on the sealing body 160 side (upper side in the drawing) of the side wall portion 152 of the recessed container 150, so that the sealing body side of the side wall portion is composed of metal, and the recessed container and the sealing body can be sealed by welding.

The shape of the exterior body in plan view may be circular or may be polygonal such as quadrangular (square or rectangular). In the case of a polygonal shape, the corners may be curved.

### (Elastic Conductive Member)

The elastic conductive member is not particularly limited as long as it has a form that functions as a leaf spring that presses the stacked electrode body toward the inner bottom surface of the recessed container. Specific examples include an elastic conductive member having a shape including a supported portion 211 having a shape corresponding to the support portion 153 of the recessed container 150 as shown in FIGS. 1 and 3, and a planar portion 212 including a spring portion (spring piece) 213; an elastic conductive member having a cross-sectional shape including an engaging portion having a shape corresponding to the support portion of the recessed container and a recess that presses the stacked electrode body; and the like.

The elastic conductive member can be formed of a plate or the like composed of nickel, iron, copper, chromium, cobalt, titanium, aluminum, and alloys thereof. Among the above examples, the metal constituting the elastic conductive member is preferably a stainless steel plate or a stainless steel plate plated with nickel, and, in order to easily exhibit a function as a leaf spring, spring stainless steel such as SUS301-CSP, SUS304-CSP, SUS316-CSP, SUS420J2-CSP, SUS631-CSP, and SUS632J1-CSP is more preferable.

The thickness of the metal plate constituting the elastic conductive member is preferably 0.05 mm or more, more preferably 0.07 mm or more, and still more preferably 0.1 mm or more, in order to make the pressing force on the stacked electrode body a certain value or more. On the other hand, in order to prevent the elastic conductive member from becoming too thick and increasing the accommodation volume in the battery container, and to make the elastic conductive member easy to deform so that it can be easily locked to the side wall portion of the recessed container, the thickness of the metal plate constituting the elastic conductive member is preferably 0.5 mm or less, more preferably 0.4 mm or less, and still more preferably 0.3 mm or less.

### EXAMPLES

Hereinafter, the present invention will be described in detail based on Examples. However, the following Examples do not limit the present invention.

### Example 1

Lithium titanate having an average particle diameter of 2 μm (Li₄Ti₅O₁₂, negative electrode active material), a sulfide-based solid electrolyte having an average particle diameter of 0.7 μm (Li₆PS₅Cl), and graphene (conductive aid) were mixed at a mass ratio of 50:41:9 to prepare a negative electrode mixture.

Further, Li_{0.98}Co_{0.94}Mg_{0.01}Al_{0.05}O₂ (positive electrode active material) having an average particle diameter of 5 μm and having a coating layer of LiNbO₃ formed on its surface, a sulfide-based solid electrolyte having an average particle diameter of 0.7 μm (Li₆PS₅Cl), and graphene were mixed at a mass ratio of 65:30.7:4.3 to prepare a positive electrode mixture.

Next, powder of a sulfide-based solid electrolyte (Li₆PS₅Cl) having an average particle diameter of 0.7 μm was placed in a powder molding die, and pressure molding was performed at a surface pressure of 70 MPa using a press machine to form a temporarily molded layer of a solid electrolyte layer. Furthermore, the negative electrode mixture was placed on the upper surface of the temporarily molded layer of the solid electrolyte layer, and pressure molding was performed at a surface pressure of 50 MPa to further form a temporarily molded layer of a negative electrode on the temporarily molded layer of the solid electrolyte layer.

Next, a foamed metal base material of Sumitomo Electric Industries, Ltd. [“CELMET” (registered trademark); made of a Ni—Cr alloy, with contents of Ni and Cr of 95 mass % and 5 mass %, respectively] cut to a diameter of 7.25 mm (thickness: 1.1 mm, porosity: 98%, basis weight: 347 g/m²) was placed as a current collector on the temporarily molded layer of the negative electrode formed on the temporarily molded layer of the solid electrolyte layer, and pressure molding was performed at a surface pressure of 300 MPa to form an integrated body of the solid electrolyte layer and the negative electrode.

Furthermore, after the mold was turned upside down, the positive electrode mixture was placed on the upper surface of the solid electrolyte layer in the mold (the surface opposite to the surface having the negative electrode), and pressure molding was performed at a surface pressure of 50 MPa to form a temporarily molded layer of a positive electrode on the solid electrolyte layer.

Next, a foamed metal base material made of a Ni—Cr alloy having the same composition as that used for the negative electrode was cut and placed as a current collector on the temporarily molded layer of the positive electrode formed on the solid electrolyte layer, and pressure molding was performed at a surface pressure of 588 MPa to obtain a stacked electrode body. The metal base material entered the molded positive electrode mixture and was integrated with the positive electrode mixture to constitute a positive electrode mixture layer.

For the obtained stacked electrode body, the thickness and diameter of the positive electrode mixture layer (the positive electrode mixture layer in which the current collector formed from the foamed metal base material and the molded body of the positive electrode mixture were integrated) were measured with a micrometer to calculate the volume of the entire positive electrode mixture layer, and the porosity of the positive electrode mixture layer excluding the current collector was determined by the method described above and was 14%.

A recessed container having the same structure as that shown in FIGS. 1 and 2, composed of ceramics, and having a seal ring composed of an iron-nickel-cobalt alloy disposed on an upper portion of a side wall portion (ceramic depth: 2.5 mm), was provided. A foamed metal base material made of a Ni—Cr alloy having the same composition as that used for the positive electrode and the negative electrode (that is, Ni and Cr contents of 95 mass % and 5 mass %, respectively) was cut to a diameter of 7.25 mm and placed on the inner bottom surface of the recessed container, and the metal base material was brought into contact with a conductive path of the positive electrode as a conductive connection member. The stacked electrode body was placed thereon with the positive electrode facing downward. Furthermore, on the negative electrode of the stacked electrode body, an elastic conductive member formed of a stainless steel plate (thickness: 0.2 mm) and having a shape similar to that shown in FIGS. 1 and 3 was placed so that its supported portions were locked to the support portions of the recessed container. The spring pieces of the elastic conductive member were bent toward the negative electrode side of the stacked electrode body, and the tips thereof were bent so as to face the flat portion side, and the spring pieces were brought into contact with the negative electrode of the stacked electrode body at portions closer to the boundary with the flat portion than the tip portions so as to press the stacked electrode body toward the inner bottom surface of the recessed container. Thereafter, a sealing body composed of an iron-nickel-cobalt alloy plate (thickness: 0.1 mm) was placed over the seal ring of the recessed container, and the sealing body and the recessed container (seal ring) were welded to seal the battery container, thereby obtaining an all-solid-state secondary battery. In the obtained all-solid-state secondary battery, as described above, the elastic conductive member pressed the stacked electrode body toward the inner bottom surface of the recessed container, whereby the stacked electrode body pressed the conductive connection member composed of the foamed metal base material. The thickness of the conductive connection member (foamed metal base material) in the all-solid-state secondary battery after assembly was 200 μm.

### Example 2

A stacked electrode body was produced in the same manner as in Example 1 except that the surface pressure during pressure molding after placing the foamed metal base material on the temporarily molded layer of the positive electrode was changed to 294 MPa, and an all-solid-state secondary battery was produced in the same manner as in Example 1 except that this stacked electrode body was used. In the stacked electrode body, the porosity of the positive electrode mixture layer was 22%.

### Example 3

A stacked electrode body was produced in the same manner as in Example 1 except that the positive electrode active material was changed to Li_{0.98}Co_{0.92}Mg_{0.01}Al_{0.07}O₂ having an average particle diameter of 5 μm and having a coating layer of LiNbO₃ formed on its surface, and an all-solid-state secondary battery was produced in the same manner as in Example 1 except that this stacked electrode body was used. In the stacked electrode body, the porosity of the positive electrode mixture layer was 14%.

### Example 4

A stacked electrode body was produced in the same manner as in Example 3 except that the surface pressure during pressure molding after placing the foamed metal base material on the temporarily molded layer of the positive electrode was changed to 441 MPa, and an all-solid-state secondary battery was produced in the same manner as in Example 1 except that this stacked electrode body was used. In the stacked electrode body, the porosity of the positive electrode mixture layer was 17%.

### Example 5

A stacked electrode body was produced in the same manner as in Example 1 except that the positive electrode active material was changed to Li_{0.98}Co_{0.90}Mg_{0.01}Al_{0.09}O₂ having an average particle diameter of 5 μm and having a coating layer of LiNbO₃ formed on its surface, and an all-solid-state secondary battery was produced in the same manner as in Example 1 except that this stacked electrode body was used. In the stacked electrode body, the porosity of the positive electrode mixture layer was 14%.

### Example 6

A stacked electrode body was produced in the same manner as in Example 5 except that the surface pressure during pressure molding after placing the foamed metal base material on the temporarily molded layer of the positive electrode was changed to 294 MPa, and an all-solid-state secondary battery was produced in the same manner as in Example 1 except that this stacked electrode body was used. In the stacked electrode body, the porosity of the positive electrode mixture layer was 22%.

### Example 7

A stacked electrode body was produced in the same manner as in Example 1 except that the positive electrode active material was changed to Li_{0.98}Co_{0.97}Mg_{0.01}Al_{0.02}O₂ having an average particle diameter of 5 μm and having a coating layer of LiNbO₃ formed on its surface, and an all-solid-state secondary battery was produced in the same manner as in Example 1 except that this stacked electrode body was used. In the stacked electrode body, the porosity of the positive electrode mixture layer was 14%.

### Example 8

A stacked electrode body was produced in the same manner as in Example 7 except that the surface pressure during pressure molding after placing the foamed metal base material on the temporarily molded layer of the positive electrode was changed to 294 MPa, and an all-solid-state secondary battery was produced in the same manner as in Example 1 except that this stacked electrode body was used. In the stacked electrode body, the porosity of the positive electrode mixture layer was 22%.

### Comparative Example 1

A stacked electrode body was produced in the same manner as in Example 7 except that the surface pressure during pressure molding after placing the foamed metal base material on the temporarily molded layer of the positive electrode was changed to 686 MPa, and an all-solid-state secondary battery was produced in the same manner as in Example 1 except that this stacked electrode body was used. In the stacked electrode body, the porosity of the positive electrode mixture layer was 7%.

### Comparative Example 2

A stacked electrode body was produced in the same manner as in Example 2 except that the surface pressure during pressure molding after placing the foamed metal base material on the temporarily molded layer of the positive electrode was changed to 686 MPa, and an all-solid-state secondary battery was produced in the same manner as in Example 1 except that this stacked electrode body was used. In the stacked electrode body, the porosity of the positive electrode mixture layer was 7%.

### Comparative Example 3

A stacked electrode body was produced in the same manner as in Example 5 except that the surface pressure during pressure molding after placing the foamed metal base material on the temporarily molded layer of the positive electrode was changed to 686 MPa, and an all-solid-state secondary battery was produced in the same manner as in Example 1 except that this stacked electrode body was used. In the stacked electrode body, the porosity of the positive electrode mixture layer was 7%.

### Comparative Example 4

A stacked electrode body was produced in the same manner as in Example 4 except that the positive electrode active material was changed to Li_{0.98}CoO₂ having an average particle diameter of 5 μm and having a coating layer of LiNbO₃ formed on its surface, and an all-solid-state secondary battery was produced in the same manner as in Example 1 except that this stacked electrode body was used. In the stacked electrode body, the porosity of the positive electrode mixture layer was 17%.

For the all-solid-state secondary batteries of the Examples and Comparative Examples, the resistance increase rate after high-temperature storage was determined by the following method.

Each of the all-solid-state secondary batteries of Examples 1 to 8 and Comparative Examples 1 to 4 was subjected to constant-current charging at a current value of 0.1 C until the voltage reached 2.6 V, and was further subjected to constant-voltage charging while being held at 2.6 V until the current value reached 0.02 C. For each battery after constant-voltage charging, after the open-circuit voltage was measured for 10 minutes, constant-current discharge was performed at a current value of 0.1 C until the voltage reached 1 V. For each battery after the open-circuit voltage was measured for 10 minutes, constant-current charging was performed at a current value of 0.1 C until the voltage reached 2.6 V, and constant-voltage charging was performed while being held at 2.6 V until the current value reached 0.2 C, and the initial resistance value of the battery (AC impedance at 1 MHz) was measured to confirm the presence or absence of a short circuit and the like.

The battery for which the initial resistance value was measured and no abnormality was found was placed in a thermostatic chamber adjusted to a temperature of 150 °C, constant-current charging was performed at a current value of 0.1 C until the voltage reached 2.6 V, and further, a voltage of 2.6 V was applied to the battery to perform constant-voltage charging, and storage was continued in the thermostatic chamber for 600 hours. During this time, under the following conditions, the direct-current resistance of the battery was repeatedly measured once every 6 hours.

Before measuring the direct-current resistance, voltage application to the battery was stopped and the battery was placed in an open state. After 10 minutes, the open-circuit voltage (OCV) of the battery was measured, and then the battery was discharged for 1 second at a current of 1 mA. A value obtained by dividing the difference (ΔV) between the battery voltage before discharge (OCV) and the closed-circuit voltage (CCV) of the battery at the end of discharge by the current value (0.001 A) was determined as the direct-current resistance. After completion of discharge, constant-current charging was again performed at a current value of 0.1 C until the voltage reached 2.6 V, then a voltage of 2.6 V was applied to the battery to perform constant-voltage charging, and further, a series of operations in which the direct-current resistance was measured under the same conditions 6 hours after the measurement was repeated. A value obtained by dividing the 100th measured value of direct-current resistance by the first measured value of direct-current resistance was determined as the resistance increase rate. A battery having a lower resistance increase rate can be said to have superior life characteristics under a high-temperature environment.

The above evaluation results are shown in Table 1 together with the amount b of Mg and the amount c of Al in the positive electrode active material (lithium cobalt oxide) in the positive electrode, and the porosity of the positive electrode mixture layer. In Table 1, the resistance increase rate after high-temperature storage is shown as a relative value with the value of the battery of Comparative Example 1 being 100.

TABLE 1

| | | | Porosity of | Resistance |
|---|---|---|---|---|
| | Lithium | | positive | increase rate |
| | cobalt oxide | | electrode | after high- |
| | Amount | Amoun | mixture | temperature |
| | of Mg b | of Al c | layer (%) | storage |
| Example 1 | 0.01 | 0.05 | 14 | 19 |
| Example 2 | 0.01 | 0.05 | 22 | 23 |
| Example 3 | 0.01 | 0.07 | 14 | 25 |
| Example 4 | 0.01 | 0.07 | 17 | 34 |
| Example 5 | 0.01 | 0.09 | 14 | 28 |
| Example 6 | 0.01 | 0.09 | 22 | 33 |
| Example 7 | 0.01 | 0.02 | 14 | 40 |
| Example 8 | 0.01 | 0.02 | 22 | 45 |
| Comparative | 0.01 | 0.02 | 7 | 100 |
| Example 1 | | | | |
| Comparative | 0.01 | 0.05 | 7 | 59 |
| Example 2 | | | | |
| Comparative | 0.01 | 0.09 | 7 | 69 |
| Example 3 | | | | |
| Comparative | 0 | 0 | 17 | 56 |
| Example 4 | | | | |

As shown in Table 1, the all-solid-state secondary batteries of Examples 1 to 8, each having a positive electrode in which lithium cobalt oxide (A) having an appropriate composition was used as the positive electrode active material and the porosity of the positive electrode mixture layer was adjusted to an appropriate value, had a low resistance increase rate after high-temperature storage and were excellent in life characteristics under a high-temperature environment.

In contrast, in the batteries of Comparative Examples 1 to 3 having positive electrodes in which the porosity of the positive electrode mixture layer was reduced, the resistance increase rate after high-temperature storage was higher than those of the batteries of the Examples regardless of the Al content, and life characteristics under a high-temperature environment were inferior. In addition, the battery of Comparative Example 4, in which lithium cobalt oxide not containing Mg and Al was used as the positive electrode active material even though the porosity of the positive electrode mixture layer was appropriate, also had a high resistance increase rate after high-temperature storage, and life characteristics under a high-temperature environment were inferior.

Although not shown in Table 1, when the porosity of the positive electrode mixture layer was made larger than 24%, not only did the resistance increase rate after high-temperature storage become large, but the ionic conductivity and initial resistance of the positive electrode mixture layer became large, which caused a decrease in load characteristics of the battery.

### Example 9

A stacked electrode body was produced in the same manner as in Example 7 except that the positive electrode active material was changed to Li_{0.98}Co_{0.968}Mg_{0.01}Al_{0.02}Ti_{0.002}O₂ having an average particle diameter of 5 μm and having a coating layer of LiNbO₃ formed on its surface, and an all-solid-state secondary battery was produced in the same manner as in Example 7 except that this stacked electrode body was used. In the stacked electrode body, the porosity of the positive electrode mixture layer was 14%.

### Example 10

A stacked electrode body was produced in the same manner as in Example 9 except that the positive electrode active material was changed to Li_{0.98}Co_{0.965}Mg_{0.01}Al_{0.02}Ti_{0.005}O₂ having an average particle diameter of 5 μm and having a coating layer of LiNbO₃ formed on its surface, and an all-solid-state secondary battery was produced in the same manner as in Example 7 except that this stacked electrode body was used. In the stacked electrode body, the porosity of the positive electrode mixture layer was 14%.

### Example 11

A stacked electrode body was produced in the same manner as in Example 10 except that the surface pressure during pressure molding after placing the foamed metal base material on the temporarily molded layer of the positive electrode was changed to 294 MPa, and an all-solid-state secondary battery was produced in the same manner as in Example 10 except that this stacked electrode body was used. In the stacked electrode body, the porosity of the positive electrode mixture layer was 22%.

### Example 12

A stacked electrode body was produced in the same manner as in Example 7 except that the positive electrode active material was changed to Li_{0.98}Co_{0.97}Mg_{0.01}Al_{0.01}Ti_{0.01}O₂ having an average particle diameter of 5 μm and having a coating layer of LiNbO₃ formed on its surface, and an all-solid-state secondary battery was produced in the same manner as in Example 7 except that this stacked electrode body was used. In the stacked electrode body, the porosity of the positive electrode mixture layer was 14%.

### Example 13

A stacked electrode body was produced in the same manner as in Example 7 except that the positive electrode active material was changed to Li_{0.98}Co_{0.935}Mg_{0.01}Al_{0.05}Ti_{0.005}O₂ having an average particle diameter of 5 μm and having a coating layer of LiNbO₃ formed on its surface, and an all-solid-state secondary battery was produced in the same manner as in Example 7 except that this stacked electrode body was used. In the stacked electrode body, the porosity of the positive electrode mixture layer was 14%.

### Comparative Example 5

A stacked electrode body was produced in the same manner as in Comparative Example 1 except that the positive electrode active material was changed to Li_{0.98}Co_{0.965}Mg_{0.01}Al_{0.02}Ti_{0.005}O₂ having an average particle diameter of 5 μm and having a coating layer of LiNbO₃ formed on its surface, and an all-solid-state secondary battery was produced in the same manner as in Comparative Example 1 except that this stacked electrode body was used. In the stacked electrode body, the porosity of the positive electrode mixture layer was 7%.

### Comparative Example 6

A stacked electrode body was produced in the same manner as in Comparative Example 1 except that the positive electrode active material was changed to Li_{0.98}Co_{0.96}Mg_{0.01}Al_{0.02}Ti_{0.01}O₂ having an average particle diameter of 5 μm and having a coating layer of LiNbO₃ formed on its surface, and an all-solid-state secondary battery was produced in the same manner as in Comparative Example 1 except that this stacked electrode body was used. In the stacked electrode body, the porosity of the positive electrode mixture layer was 7%.

For the all-solid-state secondary batteries of Examples 8 to 13 and Comparative Examples 5 and 6, the resistance increase rate after high-temperature storage was determined in the same manner as for the battery of Example 1 and the like. These results are shown in Table 2 together with the results of the batteries of Comparative Examples 1 to 3. In Table 2, the resistance increase rate after high-temperature storage is shown as a relative value with the value of the battery of Comparative Example 1 being 100.

TABLE 2

| | | | | Porosity of | Resistance |
|---|---|---|---|---|---|
| | | | | positive | increase rate |
| | Lithium cobalt oxide | | | electrode | after high- |
| | Amount | Amount | Amount | mixture | temperature |
| | of Mg b | of Al c | of Ti d | layer (%) | storage |
| Example 9 | 0.01 | 0.02 | 0.002 | 14 | 20 |
| Example 10 | 0.01 | 0.02 | 0.005 | 14 | 20 |
| Example 11 | 0.01 | 0.02 | 0.005 | 22 | 32 |
| Example 12 | 0.01 | 0.01 | 0.01 | 14 | 28 |
| Example 13 | 0.01 | 0.05 | 0.005 | 14 | 15 |
| Comparative | 0.01 | 0.02 | 0 | 7 | 100 |
| Example 1 | | | | | |
| Comparative | 0.01 | 0.05 | 0 | 7 | 59 |
| Example 2 | | | | | |
| Comparative | 0.01 | 0.09 | 0 | 7 | 69 |
| Example 3 | | | | | |
| Comparative | 0.01 | 0.02 | 0.005 | 7 | 58 |
| Example 5 | | | | | |
| Comparative | 0.01 | 0.02 | 0.01 | 7 | 73 |
| Example 6 | | | | | |

As shown in Table 2, the all-solid-state secondary batteries of Examples 9 to 13, each having a positive electrode in which lithium cobalt oxide (A) having an appropriate composition was used as the positive electrode active material and the porosity of the positive electrode mixture layer was adjusted to an appropriate value, had a low resistance increase rate after high-temperature storage and were excellent in life characteristics under a high-temperature environment.

That is, the all-solid-state secondary batteries of Examples 9 to 13, in which lithium cobalt oxide containing Mg and Al within certain ranges was used as the positive electrode active material and the porosity of the positive electrode mixture layer was adjusted to the range of 12 to 24%, were able to reduce the resistance increase rate after high-temperature storage and improve life characteristics under a high-temperature environment as compared with the all-solid-state secondary batteries of Comparative Examples 1 to 3, 5, and 6 in which the porosity of the positive electrode mixture layer was lower than 12%.

As is apparent from comparison between the battery of Example 7 and the batteries of Examples 9 and 10 having the same porosity of the positive electrode mixture layer, comparison between the battery of Example 8 and the battery of Example 11, and comparison between the battery of Example 1 and the battery of Example 13, by causing the lithium cobalt oxide to contain Ti together with Mg and Al, life characteristics under a high-temperature environment could be further improved.

In contrast, when the porosity of the positive electrode mixture layer was lower than 12%, as in the batteries of Comparative Examples 5 and 6, even if the lithium cobalt oxide used contained Ti together with Mg and Al, the resistance increase rate after high-temperature storage became high, and effects as in the Examples and Reference Examples were not obtained.

The present invention can be implemented in forms other than those described above without departing from the gist thereof. The embodiments disclosed in the present application are examples, and the present invention is not limited to these embodiments. The scope of the present invention is to be interpreted with priority given to the description of the appended claims over the description of the specification, and all modifications within the scope equivalent to the claims are included in the claims.

### INDUSTRIAL APPLICABILITY

The all-solid-state secondary battery of the present invention can be applied to the same uses as known secondary batteries including known all-solid-state secondary batteries, and is particularly suitable for uses requiring such characteristics because it is excellent in life characteristics under a high-temperature environment. The positive electrode for an all-solid-state secondary battery of the present invention can constitute the all-solid-state secondary battery of the present invention.

### DESCRIPTION OF REFERENCE SIGNS

100 all-solid-state secondary battery
110 stacked electrode body
120 positive electrode
121 molded body of positive electrode mixture
122 positive electrode current collector
130 negative electrode
131 molded body of negative electrode mixture
132 negative electrode current collector
140 solid electrolyte layer
150 recessed container
151 bottom portion
152 side wall portion
153 support portion
160 sealing body
170 connection terminal portion
171 conductive path
180 connection terminal portion
181 conductive path
190 porous metal base material
200 seal ring
210 elastic conductive member
211 supported portion
212 planar portion
213 spring portion (spring piece)
213a boundary
213b tip portion

1. A positive electrode for an all-solid-state secondary battery, comprising a positive electrode mixture layer containing a positive electrode active material, a conductive aid, and a solid electrolyte,
wherein the positive electrode contains, as the positive electrode active material, a lithium cobalt oxide represented by the following general formula (1):
LiₐCo_{1-b-c-d}Mg_{b}Al_{c}M¹_{d}O₂ (1)
[wherein, in the general formula (1), M¹ is at least one element selected from the group consisting of Ni, Mn, Na, Fe, Cu, Zr, Ti, Bi, Ca, F, P, Sr, W, Ba, Nb, Si, Zn, Mo, V, Sn, Sb, Ta, Ge, Cr, K, S, and Er, and a<1.2, 0≤b≤0.1, 0.005≤c≤0.1, and d<0.115]; and
wherein the positive electrode mixture layer has a porosity of 12 to 24%.

2. The positive electrode for an all-solid-state secondary battery according to claim 1, wherein, in the general formula (1), 0<b and d<0.1, and the porosity of the positive electrode mixture layer is 23% or less.

3. The positive electrode for an all-solid-state secondary battery according to claim 1, wherein the lithium cobalt oxide is represented by the following general formula (2):
LiₐCo_{1-b-c-d-e}Mg_{b}Al_{c}TiₑM²_{f}O₂ (2)
[wherein, in the general formula (2), M² is at least one element selected from the group consisting of Ni, Mn, Na, Fe, Cu, Zr, Bi, Ca, F, P, Sr, W, Ba, Nb, Si, Zn, Mo, V, Sn, Sb, Ta, Ge, Cr, K, S, and Er, and a<1.2, 0≤b≤0.1, 0.005≤c≤0.1, 0<e≤0.015, and f<0.1].

4. The positive electrode for an all-solid-state secondary battery according to claim 3, wherein, in the general formula (2), 0<b.

5. The positive electrode for an all-solid-state secondary battery according to claim 1, wherein a positive electrode mixture constituting the positive electrode mixture layer contains a sulfide-based solid electrolyte as the solid electrolyte.

6. The positive electrode for an all-solid-state secondary battery according to claim 1, wherein a positive electrode mixture constituting the positive electrode mixture layer contains graphene as the conductive aid.

7. The positive electrode for an all-solid-state secondary battery according to claim 6, wherein a content ratio of the graphene in the positive electrode mixture is 0.1 to 15 mass %.

8. The positive electrode for an all-solid-state secondary battery according to claim 1, wherein a content ratio of the positive electrode active material in a positive electrode mixture constituting the positive electrode mixture layer is 20 to 95 mass %.

9. The positive electrode for an all-solid-state secondary battery according to claim 1, wherein the positive electrode active material has an average particle diameter of 0.1 μm or more and 25 μm or less.

10. The positive electrode for an all-solid-state secondary battery according to claim 1, wherein the positive electrode mixture layer has a thickness of 200 μm or more and 2000 μm or less.

11. The positive electrode for an all-solid-state secondary battery according to claim 1, comprising, as a current collector, a metal foil, punching metal, a metal mesh, expanded metal, foamed metal, or a carbon sheet.

12. An all-solid-state secondary battery in which an electrode body having a positive electrode, a negative electrode, and a solid electrolyte layer interposed between the positive electrode and the negative electrode is housed in an exterior body,
wherein the positive electrode is the positive electrode for an all-solid-state secondary battery according to claim 1.

13. The all-solid-state secondary battery according to claim 12, wherein the positive electrode, the negative electrode, and the solid electrolyte layer contain a sulfide-based solid electrolyte.

14. The all-solid-state secondary battery according to claim 12, wherein the negative electrode contains lithium titanate as a negative electrode active material.
